(19) United States
(12) Patent Application Publication
(10) Pub. No.: US 2026/0336169 A1
(43) Pub. Date: Oct. 29, 2026

(54) PROCESS FOR MANUFACTURING FLOOR OR WALL COVERINGS, AND ASSOCIATED COVERINGS

(71) Applicant: GERFLOR, LYON (FR)

(72) Inventors: Freddy BOSC, LYON (FR); Patrick RAMUET, LYON (FR)

(21) Appl. No.: 19/124,365

(22) PCT Filed: Oct. 25, 2023
(86) PCT No.: PCT/FR2023/051678

§ 371 Date: Apr. 25, 2025

(30) Foreign Application Priority Data
Oct. 25, 2022 (FR) 2211096

(51) Int. Cl. B29C 41/28; B29C 41/00; B29C 41/36; B29C 41/42; B29C 41/46; B29C 41/52; B29K 27/06; B29L 31/00

(52) U.S. Cl. CPC B29C 41/28; B29C 41/003; B29C 41/36; B29C 41/42; B29C 41/46; B29C 41/52; B29K 2027/06; B29L 2031/732

(57) ABSTRACT

A process for continuously manufacturing a floor or wall covering is provided. The floor or wall covering has at least one base layer made of polymer materials, the base layer has material particles that are distributed to form a pattern. The process includes at least the steps of controlling numerical control deposition means to deposit the material particles on a continuously advancing support to form the pattern, heating the material particles to bond same and form the base layer, and separating the base layer from the support.

### TECHNICAL FIELD

The present invention relates to the technical field of floor and wall coverings made of polymer materials and their manufacturing processes. The invention relates more specifically to processes for manufacturing polyvinyl chloride or similar coverings and, more specifically, to coverings having at least one decorative layer, the decoration of which is distributed in the thickness of the layer.

### PRIOR ART

In the field of floor coverings, slabs, slats or rolls having at least one plastic material layer are well known, for example obtained from polyvinyl chloride (PVC). Known processes for manufacturing such floor coverings generally comprise a first step of depositing a first layer of granules of plastic material on a support, then in melting and pressing by means of a double-belt plate press, or with a passage between two cylinders of a calender, this layer in order to bond the granules and to obtain a decorative floor covering layer. The floor or wall covering can consist of one single decorative layer to form a homogeneous covering or several layers bonded together to form a heterogeneous covering, the decorative layer being disposed in the upper part of the floor covering.

This type of decorative layer has the advantage of having a “mass” decoration, i.e. in the entire thickness of the decorative layer. In fact, the decoration presented by the layer does not degrade with wear and after successive cleaning operations, which gives the covering great longevity. However, these decorations are obtained by randomly sprinkling a thickness of granules over the entire surface of a pressing support, and it is not possible to reproduce a desired pattern, “approaching” decoration is thus referred to.

A known alternative consists of replacing the decorative layer with a printed decorative film covered with a transparent wear layer. However, once the wear layer is worn, the decorative layer is immediately deteriorated.

### SUMMARY OF THE INVENTION

One of the aims of the invention is to overcome the disadvantages of the prior art, in particular by proposing a process for manufacturing a floor or wall covering having a base layer comprising a pattern in the thickness of the layer, the pattern being predefined.

Another aim of the invention is to propose a process for manufacturing a floor or wall covering having an upper layer comprising a relief pattern, the relief pattern being predefined.

A third aim of the invention is to propose a process for manufacturing a floor or wall covering having a base layer comprising a pattern in the thickness of the layer, the pattern being predefined and an upper layer comprising a second relief pattern, the second relief pattern being predefined.

To this end, a process for continuously manufacturing a floor or wall covering having at least one base layer made of polymer materials has been developed, said base layer comprising material particles that are distributed to form a pattern, involving at least the steps of:
controlling numerical control deposition means to deposit the material particles on a continuously advancing support to form the pattern,
heating the material particles to bond same and form the base layer,
separating the base layer from the support.

This process thus makes it possible to obtain a decoration in the thickness of the base layer, the decoration being obtained by the combination of the pattern obtained by the distribution of the material particles and possible other materials of the base layer. The base layer obtained forms a layer enabling the manufacture of a homogeneous, single-layer floor or wall covering, or which could optionally be subsequently bonded to other layers so as to form a heterogeneous floor covering.

According to a first alternative, the support is therefore used only to obtain the floor or wall covering, and is then disconnected from the covering. The support can, for example, comprise a continuous conveyor belt or a transfer paper, for example a paper coated with a silicone layer on the face intended to receive the distributed material particles, or also a textile. In this case, the floor or wall covering obtained from the process is a homogeneous covering, having only one single layer and the process according to the invention makes it possible to manufacture a decoration comprising a predefined pattern over all or some of the thickness of the base layer, and therefore of the covering.

Alternatively, the process for continuously manufacturing a floor or wall covering having at least one base layer made of polymer materials, said base layer comprising material particles that are distributed to form a pattern, involves at least the steps of:
controlling numerical control deposition means to deposit material particles on a continuously advancing support to form the pattern,
heating the material particles on the support to bond same and form the base layer, the support being secured to the base layer.

This process thus makes it possible to obtain a heterogeneous covering comprising a decoration in the thickness of the base layer, this being obtained by the combination of the pattern obtained by the distribution of the material particles and possible other materials of the base layer. This process can require means for advancing the support, such as unwinders, rollers or a conveyor belt, so as to advance the support during the deposition, heating and possibly pressing steps.

In this second case, the support is therefore intended to be secured to the base layer and therefore, to the floor or wall covering. It can thus comprise a frame, such as a glass web, a polyester non-woven item or a layer obtained from a thermoplastic, for example, a layer obtained from PVC. This makes it possible to obtain a reinforced and/or heterogeneous floor or wall covering, insofar as it comprises several layers. A layer obtained from PVC can, for example, be made by calendering, coating and then gelling, by pressing or also by extrusion through a flat die, this layer being presented in the form of a sheet having two smooth faces.

Whatever the embodiment, the deposition means can comprise at least one particle storage means comprising at least one outlet, for example a hopper, as well as at least one closure means for each outlet, which is controllable by numerical control, so as to stop or let the particles flow in a controlled manner, the particle storage means and the closure means together forming a distribution device. Each deposition means can, for example, store a particle type, a colour for example, so as to mix several particle types in the pattern using several deposition means.

Whatever the embodiment, the deposition means can comprise a distribution device, the pattern being predefined in a digital file or any equivalent computer storage means, the distribution device comprising means for reading and interpreting said file or computer storage means to numerically control the deposition means according to the pattern and deposit the particles according to the pattern. The distribution device can, in particular, comprise a control computer associated with a microcontroller controlling a particle distribution device. The computer makes it possible to interpret the predefined pattern and to establish a series of operations of the microcontroller. The microcontroller makes it possible, for example, to control the particle distribution device according to movements, position and quantity parameters of particles to be deposited established by the computer according to the predefined pattern. Thus, whatever the embodiment, the pattern can be predefined in a digital file and the invention makes it possible to obtain a decorative layer, the pattern of which repeats a little, contrary to fully mechanical processes. The invention makes it possible to avoid, for example, using heliogravure processes, the cylinders of which generally have a development of less than three metres. It is also possible that the pattern is continuously renewed by computer pattern generation means, so as not to be repeated identically, but to bring, for example, slight variations in colour or geometry, the pattern remaining predefined during the step of controlling the deposition means.

Whatever the embodiment, the process according to the invention can comprise several successive steps of controlling numerical control deposition means, to deposit the material particles on a continuously advancing support to form the pattern, so as to obtain a defined pattern extending into the thickness of the base layer.

Whatever the embodiment, by continuously advancing, this means that the support continuously moves with respect to the step-by-step deposition or advancement means with respect to the deposition means.

Whatever the embodiment, the polymer materials for manufacturing the base layer can be deposited in whole or in part during the step which consists of controlling numerical control deposition means to deposit the material particles on a continuously advancing support to form the pattern. In this case, the particles comprise particles made of polymer materials.

Whatever the embodiment, the polymer materials for manufacturing the base layer can be deposited in whole or in part before or after the step which consists of controlling numerical control deposition means to deposit the material particles on a continuously advancing support to form the pattern. In this case, the deposited particles can comprise particles made of polymer and/or non-polymer materials.

Several supports intended to be secured to the base layer can be considered. In particular, the support can comprise a reinforcement frame such as a reinforcement grid or a non-woven textile layer, such as a glass or polyester web. Materials in the form of fibres being able to be used to obtain a reinforcement frame are, in particular, polyethylene, polyethylene terephthalate (PET), glass fibres, polyester fibres, aramid, carbon fibres, nitrile fibres, ethylene vinyl acetate (EVA), high density polyethylene (HDPE), low density polyethylene (LDPE), polyvinyl chloride (PVC).

The support can also comprise a backing layer made of polymer materials. A backing layer in sheet form can, for example, be obtained from coloured granules, for example, made of PVC then pressed, or also by coating and gelling with a coloured PVC plastisol, by flat die extrusion or by calendering.

The polymer materials being able to be used in the composition of the base layer, the particles and/or a backing layer are, for example, PVC, PVB, PLA, TPU, PPMA, cellulose derivatives, elastomers, individually or in mixtures.

According to an alternative, the process for continuously manufacturing a floor or wall covering according to the invention comprises at least one step, prior to the step of depositing the material particles by deposition means controlled by numerical control and consisting of:
depositing a liquid plastisol layer on the continuously advancing support,
optionally, pre-gelling the plastisol layer.

In this way, it is possible to integrate particles into a covering obtained by coating, according to a predefined pattern. According to the density of the particles and to the level of pre-gelling of the plastisol, it is possible to distribute the particles in the thickness of the base layer. In this case, the plastisol layer is non-gelled or partially gelled. Indeed, contrary to calendering, pressing or extrusion processes, the plastisol coating processes do not make it possible to incorporate directly into the plastisol, grindings of recycled coverings coming from offcuts or other recycled materials. The invention thus makes it possible to manufacture layers and coverings obtained from coating processes comprising a predefined pattern and advantageously of which, the environmental footprint is reduced.

Alternatively, the process for continuously manufacturing a floor or wall covering according to the invention comprises at least one step prior to the step of depositing the particles and of:
controlling numerical control deposition means to deposit a fluid adhesive material layer on a continuously advancing support, then deposit the material particles on the fluid adhesive material layer to form the pattern.
   The fluid adhesive material can, in particular, be a varnish, in particular, acrylic-or polyurethane-based, a liquid adhesive, a plastisol.

The fluid adhesive material is advantageously deposited in drops having a volume of between 1 picolitre and 1 millilitre. Alternatively, the fluid adhesive material can be replaced by an adhesive material in powder form. As an example, the adhesive material can comprise a hot-melt powder, a varnish in powder form.

Whatever the embodiment, and so as to obtain a uniform base layer and covering thickness, the manufacturing process according to the invention can comprise at least one additional step of pressing the material particles onto the support. This step can be carried out before the heating step, or simultaneously with the step of heating the deposited particles.

Whatever the embodiment and preferably, the manufacturing process according to the invention comprises deposition means which are movable with respect to the continuously advancing support. This makes it possible, for example in the case of a support advancing in a plane (X, Y) along an axis (Y), to deposit particles transversely to the support, i.e. according to a position on the axis (X) and/or in the axis of the support (Y), without having to multiply the number of deposition means. Complementarily, the deposition means can be movable with respect to the support along an axis (Z) perpendicular to the plane (X, Y) of advancement of the support, so as to produce a three-dimensional pattern, in the thickness of the base layer.

Preferably, the manufacturing process according to the invention comprises at least one additional step before the heating step, of:
depositing a material particle layer on the continuously advancing support.

This step consists of depositing a particle “bed” being able to be variable or constant on the continuously advancing support. These particles are randomly distributed and form a non-predefined pattern. It is, for example, possible to deposit material particles in the form of granules, powders or “dry blend” according to a random pattern upstream of the step which consists of controlling numerical control deposition means to deposit the material particles on a continuously advancing support to form the pattern. The process can thus comprise an additional step of controlling numerical control deposition means to deposit the material particles on the bed of particles deposited randomly to form the pattern. This alternative makes it possible, for example, to obtain marbled decorations having a bottom layer according to a random pattern and veins obtained by the particles deposited according to a predefined pattern. This alternative also makes it possible to integrate particles deposited according to a random pattern in the layer, and therefore in coverings, materials coming from recycling. The process according to the invention therefore makes it possible to obtain a new covering type, mixing materials coming from recycling in a base layer made of polymer materials.

The invention also relates to a floor or wall covering having at least one base layer obtained by a manufacturing process according to the invention. The covering thus comprises a predefined pattern and “mass” extending, i.e. into all or some of the thickness of the base layer. As an example, it is considered that a decoration is “mass” when it extends over a thickness of the base layer greater than 0.1 mm, even greater than 0.3 mm and up to 6 mm, in order to resist wear due to traffic.

Advantageously, the material particles deposited to form the pattern are particles made of polymer materials such as PVC, polypropene, polyethylene, PMMA, linoleum, thermosets, individually or as a mixture, or also from non-polymer materials such as corundum or glass.

Advantageously, the particles are granules with a particle size of between 0.5 mm and 10 mm, or also powders with a particle size of between 2 μm and less than 500 μm, preferably between 20 μm and 250 μm. Said particles can also comprise a mixture of granules and powders. The process according to the invention can thus comprise a step of controlling numerical control deposition means to deposit granules and/or powders on a continuously advancing support to form the pattern.

The material particles deposited to form the pattern can also comprise at least one mineral, natural or synthetic filler.

The material particles deposited to form the pattern can also comprise at least one plasticiser.

The particles of materials deposited to form the pattern can come from a recycling channel.

The particles of materials deposited to form the pattern can have a spherical and/or ovoid shape to improve the flowability and fineness of the pattern, as well as its repeatability. Indeed, particles of coarse shape such as particles obtained by grinding post-consumer products or others do not flow homogeneously and can induce variability during the deposition step. In particular, spherical and/or ovoid particles can be obtained by well-known processes of extrusion through a hole die with underwater blade cutting.

The material particles deposited to form the pattern can be presented in the form of a PVC dry-blend or in the form of granules obtained from a gelled polymer material such as PVC.

The material particles deposited to form the pattern can be presented in the form of coloured granules, each granule comprising one or more colours.

### BRIEF DESCRIPTION OF THE DRAWINGS

FIG. 1 is a side view of a first example of a base layer obtained by a process according to the invention.

FIG. 2 is a side view of a second example of a base layer obtained by a process according to the invention.

FIG. 3 is a side view of a third example of a base layer obtained by a process according to the invention.

FIG. 4 is a side view of a fourth example of a base layer obtained by a process according to the invention.

FIG. 5 is a perspective view of a distribution device for the distribution controlled by numerical control of particles.

FIG. 6 is a top view of the distribution device for the controlled distribution of particles presented in FIG. 1.

FIG. 7 is a side view of a second distribution device for the distribution controlled by numerical control of particles.

FIG. 8 is a side view of a fifth example of a base layer obtained by a process according to the invention.

FIG. 9 is a side view of a sixth example of a base layer obtained by a process according to the invention.

FIG. 10 is a side view of a seventh example of a base layer obtained by a process according to the invention.

FIG. 11 is a side view of an alternative having a support printed with a decorative layer.

FIG. 12 is a side view of an alternative having a base layer printed with a decorative layer.

### DETAILED DESCRIPTION OF THE INVENTION

Whatever the embodiment, the material particles being able to be distributed are presented in bulk, for example in the form of powders and/or granules. The granules being able to be used for manufacturing a base layer according to the invention can be of the same or different natures. As an example, the polymer materials being able to be used can be chosen from among PVC, PP, PE, PMMA, as well as product offcuts or grindings coming from recycling channels of these materials. Alternatively, the particles can comprise linoleum.

In the case of PVC, this can be used in different forms for the manufacture of granules. As an example, the granules are obtained from PVC, optionally with a filler, optionally with plasticiser, mixed, then gelled in a mixer. A conventional process for obtaining plasticised granules involves at least the steps of:
heating a quantity of powdered PVC between 80 °C and 90 °C, then adding a quantity of plasticiser to it,
heating the mixture obtained up to around 110 °C, such that the PVC is plasticised,
cooling the plasticised PVC mixture, in order to incorporate a quantity of filler, stabilisers, pigments or other additives with it, and mix. The mixture obtained is presented in the form of a powder called “dry blend”,
gelling this “dry blend” by heating it to 170 °C in a continuous extruder, or in batches in an “internal” mixer,
extruding the mixture through a hole die, then cutting the molten material beads, in order to obtain granules of 0.5 to 5 millimetres of cross-section, and a length of 0.5 to 10 millimetres.

According to an alternative, the distributed materials according to the invention are presented in powder, even “dry blend” form, i.e. in polymer material powder form, for example, PVC, plasticised and non-gelled. In this case, the process according to the invention involves a step of distributing “dry blend”-form particles on a support according to a predefined pattern, then of gelling this “dry blend”, for example, using a heating press. Using dry blend makes it possible to obtain a better resolution of decorations with regard to the particle being able to be obtained with this powder type. Preferably, and so as to facilitate its handling by the deposition means, the deposited powder has a particle size of between 1 μm and 250 μm. As an example, a dry blend commonly used for preparing PVC granules has a density of around 0.50, a volume mean diameter of 136 μm, a D50: 140 μm, a 63 μm D10 and a 198 μm D90. Using dry blend also makes it possible to remove the granulation step commonly used for manufacturing PVC floor covering by making it possible to directly manufacture a pattern. This granulation operation is expensive in time, equipment and energy. The distribution of a dry blend is also facilitated with respect to that of granules which generally have a wider particle size distribution. It is thus easier to obtain a homogeneous deposition in thickness, for example for manufacturing a “bed”, a regular layer.

In the case of linoleum, it is possible to adapt the process according to the invention in order to obtain a pattern from a distribution of linoleum paste. A linoleum paste is presented in powder form obtained from a mixture of linoleum cement mixed with cork powder, wood flour and dyestuffs, such as pigments. The process thus comprises an additional step of pressing and heating the layer comprising the linoleum paste, so as to crosslink this paste and obtain the base layer.

It is naturally possible to mix several types of materials to be deposited to obtain a pattern according to the invention. As non-limiting examples, the materials being able to be deposited can be granular materials in the form of powders, granules, grit, flakes, strips or any other materials in particulate or substantially particulate form. More specifically, these can be pearls, pigments, pure or coated in the form of pigment paste, non-slip particles.

Following the deposition step by the numerically controlled deposition means, it can be considered to preheat the deposited materials so as to pre-gel them and/or hold them on the support, for example, by exposure under infrared radiation.

The presses being able to be used with the process according to the invention are, for example, single-belt presses, double-belt presses or alternatively, calenders comprising at least two cylinders.

The heating step can, for example, be carried out using a furnace or by exposure to infrared radiation.

The continuous advancement means being able to advance the support can, for example, comprise a conveyor belt, rollers, belts or similar.

The base layer according to the invention generally has a thickness of between 0.3 and 6 millimetres.

The base layer can optionally be varnished and/or bonded to a backing layer on its lower face and/or bonded to an upper layer on its upper face, for example, transparent wear layer.

The base layer can form a floor or wall covering in rolls, even be cut to form a floor covering in plates, slabs or slats. Assembly means can, in particular, be machined on the edges of each slab or slat, in order to enable them to be bonded together. Such means are described, in particular, in documents WO2016030627, US20130309441 or EP3105392. Plates, slabs or slats can have a dimension of between 0.10 and 3.5 metres long and 0.10 and 2.6 metres wide.

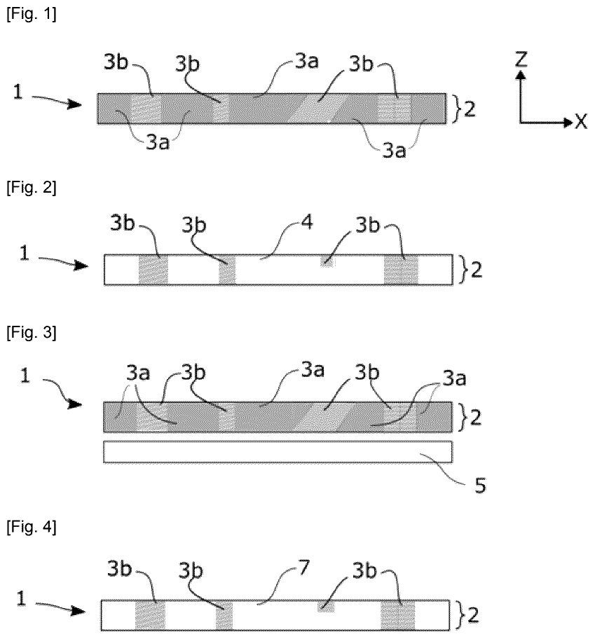

According to FIG. 1, a first example of a floor or wall covering (1) having a base layer (2) obtained by a manufacturing process according to the invention is described. The base layer (2) is presented in the form of a film having an upper face intended to be in contact with the user and a lower face intended to be in contact with the floor. The covering (1) consists only of the base layer (2), except for a particular embodiment, where this is covered with a varnish (not represented) on its upper face. The base layer (2) comprises polymer material particles (3a, 3b) that are distributed by numerical control deposition means to form a pattern along the three axes of a three-dimensional system (X, Y, Z), and so as to be distributed in all or some of the thickness of the layer (2). The covering is thus obtained fully from particles that are distributed by numerical control deposition means. Some of the polymer particles (3b) can optionally be substituted by non-polymer particles. A process for continuously manufacturing a floor or wall covering comprising a base layer (1) according to this first example made of polymer materials, said base layer comprising material particles that are distributed to form a pattern involves at least the steps of:
controlling numerical control deposition means to deposit the material particles (3a, 3b) on a continuously advancing support (not represented) to form the pattern,
heating the material particles to bond same and form the base layer,
separating the base layer from the support.

The polymer material particles (3a, 3b) can be presented in powder form, for example, of PVC “dry blend”, coloured or not, even of gelled PVC granules, individually or in mixtures. According to the type of materials, it can be necessary to carry out a hot pressing step of the deposited particles to obtain a base layer of homogeneous thickness.

According to FIG. 2, a second example of a floor or wall covering (1) having a base layer (2) obtained by a manufacturing process according to the invention is described. The covering (1) consists only of the base layer (2), except for a particular embodiment, where this is covered with a varnish (not represented) on its upper face. The base layer (2) comprises particles of randomly deposited polymer materials (4), as well as material particles (3b) that are distributed by numerical control deposition means to form a pattern along the three axes of a three-dimensional system (X, Y, Z), and so as to be distributed in all or some of the thickness of the layer (2). The covering is thus obtained in part from particles (3b) that are distributed by numerical control deposition means. A process for continuously manufacturing a floor or wall covering having at least one base layer according to this second example made of polymer materials, said base layer comprising material particles that are distributed to form a pattern, involves at least the steps of:
randomly depositing polymer particles on a continuously advancing support, so as to form a layer (4),
controlling numerical control deposition means to deposit material particles (3b) on the support or on the layer of randomly deposited polymer particles (4) to form the pattern,
heating the material particles on the support to bond same and form the base layer (2). In this example, the material particles (3b) are not necessarily polymeric.

According to FIG. 3, a third example of a floor or wall covering (1) having a base layer (2) obtained by a manufacturing process according to the invention is described. The covering (1) comprises a base layer (2) and a support (5), the upper face of the base layer (2) being able to be covered with a varnish (not represented) on its upper face. The support (5) is secured to the base layer (2) and can be, for example, a layer obtained from polymer materials or a reinforcement frame. The base layer (2) of FIG. 3 shows the features of the base layer presented in FIG. 1, namely that this comprises polymer material particles (3a, 3b) that are distributed by numerical control deposition means to form a pattern along the three axes of a three-dimensional system (X, Y, Z), and so as to be distributed in all or some of the thickness of the layer (2). The base layer (2) is thus obtained fully from particles (3a, 3b) that are distributed by numerical control deposition means. A process for continuously manufacturing a floor or wall covering having at least one base layer (2) according to this third example made of polymer materials, said base layer comprising material particles that are distributed to form a pattern, involves at least the steps of:
controlling numerical control deposition means to deposit material particles (3a, 3b) on a continuously advancing support (5) to form the pattern,
heating the material particles (3a, 3b) on the support (5) to bond same and form the base layer (2), the support being secured to the base layer.

Advantageously, and such as illustrated in FIG. 11, the support (5) can, prior to the particle deposition step, have been printed with a decorative layer (8) by any known means, in particular by an inkjet printing process, the support being intended to remain secured to the base layer (2). FIG. 11 shows the elements described according to FIG. 3, a decorative layer (8) being interposed between the base layer (2) and the support (5). According to this embodiment, the process according to the invention can comprise a step preliminary to the particle deposition step of providing a support (5) and of printing the support (5) with a decorative layer (8) by any known means, in particular by an inkjet printing process. Advantageously, the pattern of the decorative layer (8) is known, such that the process according to the invention involves the steps of:
recognising the position of the pattern of the decorative layer (8) on the support (5),
depositing the material particles (3a, 3b) according to a predefined pattern according to the position of the pattern of the decorative layer (8) on the support (5), and so as to record the two patterns.
   The recognition step can be carried out using any known means, such as positioning cards, cameras or other optical recognition means being able to be interfaced with the numerical control deposition means.

Alternatively, the features of the base layer (2) can show the features of the base layer presented in FIG. 2, namely that the base layer comprises randomly deposited polymer material particles, as well as material particles deposited by numerical control deposition means. The covering is thus obtained partly from particles (3b) that are distributed by numerical control deposition means and the support (5) remaining secured to the base layer (2) thus formed.

According to FIG. 4, a fourth example of a floor or wall covering (1) having a base layer (2) obtained by a manufacturing process according to the invention is described. The base layer (2) comprises a gelled plastisol layer (7) comprising material particles (3b) that are distributed by numerical control deposition means to form a pattern along the three axes of a three-dimensional system (X, Y, Z), and so as to be distributed in all or some of the thickness of the layer (2). The covering is thus obtained partially from particles that are distributed by numerical control deposition means. A process for continuously manufacturing a floor or wall covering having at least one base layer according to this fourth example made of polymer materials, said base layer comprising material particles that are distributed to form a pattern, involves at least the steps of:
depositing a liquid plastisol layer on a continuously advancing support (not represented),
optionally, pre-gelling the plastisol layer,
controlling numerical control deposition means for depositing material particles (3b) on the plastisol layer,
heating the material particles on the support to bond same and form the base layer.
   In the abovementioned case, the step of forming the base layer comprises a step of gelling the plastisol layer.
   Naturally, the base layer (2) having a gelled plastisol layer (7) can also be deposited on a support (5) intended to be secured to the base layer (2). Complementarily, prior to the particle deposition step, the support (5) can have been printed with a decorative layer (8), similarly to the example described according to FIG. 11.

According to FIG. 8, a fifth example of a floor or wall covering (1) having a base layer (2) obtained by a manufacturing process according to the invention is described. The base layer (2) comprises a gelled plastisol layer (7) comprising material particles (3b) that are distributed by numerical control deposition means to form a pattern along the three axes of a three-dimensional system (X, Y, Z), and so as to be distributed in all or some of the thickness of the layer (2) and to form a relief pattern on the surface of the base layer (2), the pattern being predefined by the position of the particles (3b). At least some of the particles (3b) are flush beyond the thickness of the plastisol layer (7) to form a relief. The particles (3b) can thus be non-slip particles and/or form a decorative relief pattern.

According to FIG. 9, a sixth example of a floor or wall covering (1) having a base layer (2) obtained by a manufacturing process according to the invention is described. The base layer (2) comprises a first layer of gelled plastisol (7) comprising material particles (3b, 3c) that are distributed by numerical control deposition means to form a pattern along the three axes of a three-dimensional system (X, Y, Z), and so as to be distributed in all or some of the thickness of the layer (2). The base layer also comprises a second gelled plastisol layer (7′) bonded to the first gelled plastisol layer (7) and comprising material particles (3b, 3c) that are distributed by numerical control deposition means to form a pattern along the three axes of a three-dimensional system (X, Y, Z) and to form a relief pattern on the surface of the base layer (2), the pattern being predefined by the position of the particles (3b, 3c). At least some of the particles (3b, 3c) are flush beyond the thickness of the plastisol layer (7′) to form a relief. The particles (3b, 3c) can thus be non-slip particles and/or form a decorative pattern. The second plastisol layer (7′) can be transparent or translucent to reveal the first plastisol layer (7).

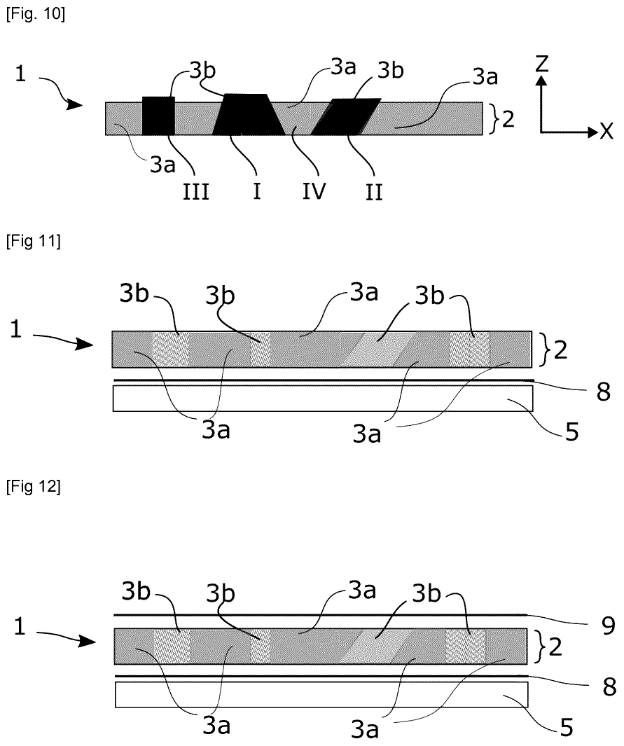

According to FIG. 10, a seventh example of a floor or wall covering (1) having a base layer (2) obtained by a manufacturing process according to the invention is described. The base layer (2) is presented in the form of a film having an upper face intended to be in contact with the user and a lower face intended to be in contact with the floor. The covering (1) consists only of the base layer (2), except for a particular embodiment, where this is covered with a varnish (not represented) on its upper face. The base layer (2) comprises polymer material particles (3a, 3b) that are distributed by numerical control deposition means to form a pattern along the three axes of a three-dimensional system (X, Y, Z), and so as to be distributed in all or some of the thickness of the layer (2). The particles (3a, 3b) are of different size and/or shape, such that at least some of the particles (3b) are flush beyond the general thickness of the layer (2) formed by the mixture of the particles (3a) and (3b) to form a relief element according to a predefined pattern.

Alternatively and such as illustrated in FIG. 12, and whatever the embodiment of the base layer (2), the process according to the invention can also comprise, after the step of heating the material particles, once the base layer (2) has been formed, a step of printing a superficial decorative layer (9) by any known means, in particular by an inkjet printing process. This printing step can be carried out before or after the optional step of pressing the material particles onto the support. Advantageously, the pattern of the superficial decorative layer (9) is known, such that the process according to the invention involves steps of:
recognising the position of the pattern of the base layer (2),
printing the pattern of the superficial decorative layer (9) according to the position of the pattern of the base layer (2), and so as to record the two patterns.
   The recognition step can be carried out using any known means, such as positioning cards, cameras or other optical recognition means being able to be interfaced with the numerical control deposition means.

It is also possible to combine a base layer (2) printed with a superficial decorative layer (9) with a support (5) previously printed with a decorative layer (8), so as to obtain a very complex visual appearance. The covering obtained thus comprises, from top to bottom, an optionally varnished superficial decorative layer (9) (not represented), a base layer (2) according to the invention, optionally a decorative layer (8) printed on a support (5) or a non-printed support (5).

Whatever the embodiment and such as illustrated according to FIG. 10, the deposited particles (3a, 3b) can be presented according to a cross-sectional view in the plane (X, Z) as a cluster forming various shapes according to their deposition method. Particles deposited during a first deposition step will present a frustoconical cross-sectional view (I), the width of which decreases towards the upper face of the layer (2). Particles deposited during a second deposition step along a first cluster will form a parallelepiped cluster (II). Distinct particles (3a, 3b) deposited during a simultaneous deposition step can have the form of two clusters, at least one edge of which is substantially vertical (III). Particles deposited during a second deposition step between two previously deposited frustoconical clusters will have the shape of a frustoconical cluster widening towards the surface of the layer (IV).

In a first case, the support can be temporary, for example, a conveyor belt and the process comprises an additional step of separating the support from the base layer. In a second case, the support is intended to be integrated into the base layer and consists, for example, of a reinforcement frame.

Generally, the step of controlling numerical control deposition means to deposit material particles on a continuously advancing support to form the pattern can be made by a device for the controlled distribution of material particles, such as granules and/or powders. As an example, this device can comprise at least one particle storage hopper having at least one outlet. The outlet being able to be closed or opened by numerical control, so as to let the particles stored in the hopper to flow onto a support.

Several existing processes and devices make it possible to deposit particles according to a numerically defined pattern. A first process is described in patent EP2257773, which presents a device and a process for the controlled distribution of solid bulk, granular and/or powder materials used in manufacturing ceramic products.

In particular, a device is described, which comprises a hopper being able to contain a bulk material to be distributed, which is provided with at least one outlet, through which the material flows freely from the hopper, for example, only by the force of gravity. The device further comprises a vibrating distribution element, which is located below the outlet, disposed vertically facing it, and a means for vibrating the vibrating distribution element, making it possible to vibrate it by numerical control. In this manner, the particles accumulated on the vibrating distribution element slide at least towards a descending edge of the distribution device, from which these can freely fall onto a support, only when the distribution element is vibrating. The distribution element is inclined with respect to a hypothetical horizontal plane, so as to define a sliding direction of the material towards at least one descending front.

The inclination is between 0° and 10° with respect to the horizontal, such that the material leaving the outlet can accumulate on the distribution element without sliding on it by the simple effect of gravity. The outlet is sized according to the size of the particles to be deposited, so as to obtain a good flow of these. The dosage of the quantity of material to be deposited is obtained over time, and according to the intensity of the vibrations of the distribution element. In this manner, a numerical control system for the vibrating means of the vibrating distribution element makes it possible to selectively distribute the particles. Thus, by disposing a plurality of similar devices facing a support, it is possible to obtain a predefined pattern digitally, by controlling the selective deposition of each particle type on the support according to its position defined in the pattern. As an example, the pattern can be predefined in a digital file, and the device comprises means for reading and interpreting said file in order to numerically control the deposition means according to the pattern.

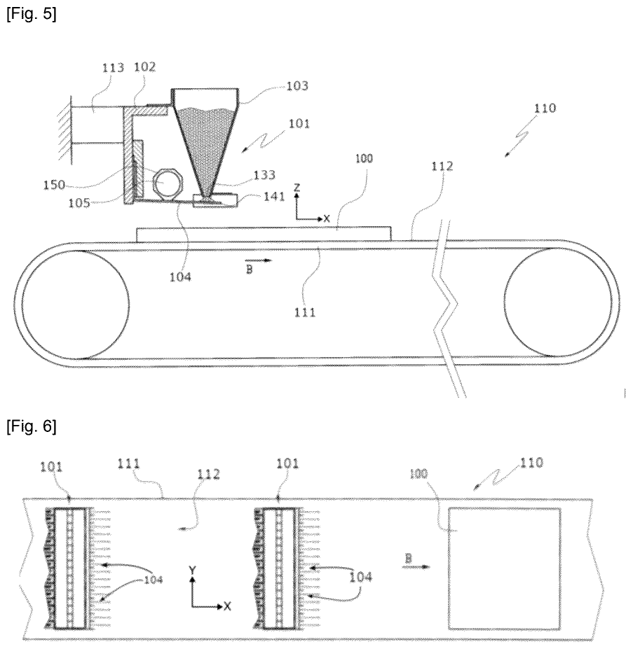

FIGS. 5 and 6 illustrate an example of an embodiment of such a device. This enables the manufacture of plate products by a controlled deposition of particles on a support (100). It comprises at least one distribution device for the numerically controlled distribution of particles (101), in which each distribution device comprises a bulk material storage hopper (103) provided with a plurality of outlets (133), a plurality of distribution elements (104), each being located facing an outlet (133), such that the material exiting each outlet (133) can accumulate there without flowing. Each distribution element (104) is inclined with respect to a horizontal plane, in order to define a sliding direction of the material towards at least one descending edge (141) of the distribution element (104). The device also comprises several vibrating means (105, 150), each being associated with a respective distribution element (104) for vibrating said distribution element (104), such that the accumulated material slides upwards on the distribution element (104), until the material falls from the descending edge (141) of the latter when this is vibrating.

The distribution elements are inclined according to an inclination of between 0° and 10° with respect to the horizontal plane. Numerical control means for activating each vibration means (105, 150) independently of one another, not represented, are also provided. The device also comprises advancing means (111) for carrying out a relative movement in at least one advancing direction (B) between the distribution device (101) and the support (100) on which the particles must be distributed. These advancing means can, for example, comprise a continuous conveyor belt (111) transporting the support (100) on an upper face (112) of the belt, this being driven by an electronically controlled motor.

The distribution device (101) is stably fixed to a fixed support (113, 102) with respect to the continuous conveyor belt (111). A plurality of devices (101) can thus be disposed transversely to the continuous conveyor belt (111). In this manner, the distribution device (101) can act in sequence on the support (100), in order to increase the range of patterns and/or decorative effects which can be achieved. In particular, the hoppers (103) of the distribution devices (101) can be filled with particles having a different colour, density, hardness, gloss, with the aim of obtaining predefined patterns and/or textures and having several colours and/or materials. Thus, each distribution device (101) is intended to deposit a specific material, for example, a colour, on the support (100).

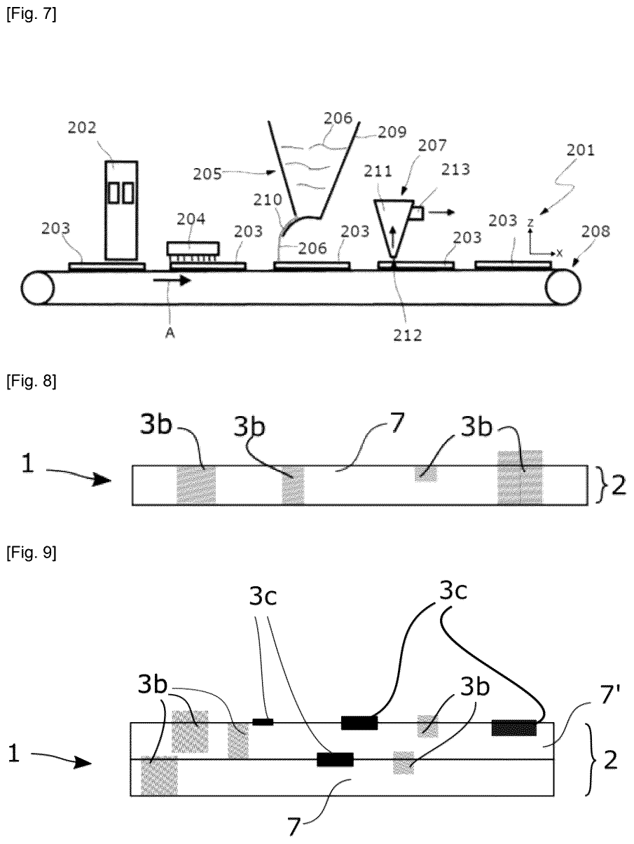

A second process making it possible to control numerical control deposition means to deposit material particles on a continuously advancing support to form the pattern is described in patent EP2892657. This patent describes a process and a device (201) for manufacturing predefined decorative patterns by numerical control on products from materials in the form of particles. According to FIG. 7, this process comprises the steps of applying on the surface of a support (203), at least one fluid adhesive material layer, depositing material particles (206) on the adhesive material layer, and removing the excess material particles (206). The fluid adhesive material is of the radiation exposure hardening type, or has a sticky consistency in contact with air or in contact with a “primer” previously spread over the surface of the support (203) having to be decorated.

The step of applying at least one fluid adhesive material layer can comprise ejecting adhesive material microdrops on the surface of the products (203) having to be decorated by means of a digital printhead (202) provided with piezoelectrically-controlled ejection nozzles. Still according to FIG. 7, the device (201) comprises a digital printhead (202) for applying, on the surface of the support (203), at least one fluid adhesive material layer being able to be hardened by exposure to radiation. The device (201) comprises radiating means (204) adapted to irradiate the adhesive material layer. The irradiation of the adhesive material layer, for a predefined period of time, determines its rapid transformation into a substantially transparent and glue-like film which is suitable for the subsequent deposition of material particles. The device (201) thus comprises means (205) for depositing particles of materials (206) on the adhesive material layer, after this has undergone irradiation under the radiating means (204) and has thus taken on a glue-like consistency. The means (205) for depositing the material particles comprise, for example, a hopper (209) opening onto a closable outlet (210) which, in the open position, lets the particles stored in the hopper (209) to flow regularly. The device (201) also comprises means (207) for removing excess material particles (206), which are deposited on the support (203). These means (207) make it possible to remove the material particles (206) which have not bonded directly to the adhesive material layer, and which therefore remain in excess, since they cannot be incorporated into the pattern being made. The means (207) for removing the excess material particles (206) comprise, for example, at least one suction hood (211) disposed such that its suction mouth (212) is close to the upper surface of the products (203) to be decorated supported by a continuous belt conveyor (208). The suction hood (211) can also comprise a discharge mouth (213) through which, by suitable conduits, not represented in the figures, the excess material particles (206) can be returned to the inside of the hopper (209), or conveyed to a special collection zone.

The supports to be decorated (203) are disposed on the continuous belt conveyor (208) and advance along a direction A continuously. The digital printhead (202) is provided with one or more respective individual heads, each being equipped with adhesive material ejecting nozzles on the upper surface of the products (203) to be decorated.

1. A process for continuously manufacturing a floor or wall covering having at least one base layer made of polymer materials, said base layer comprising material particles that are distributed to form a pattern, said method comprising at least the steps of:
controlling numerical control deposition means to deposit the material particles on a continuously advancing support to form the pattern,
heating the material particles to bond same and form the base layer, and
separating the base layer from the support.

2. A process for continuously manufacturing a floor or wall covering having at least one base layer made of polymer materials, said base layer comprising material particles that are distributed to form a pattern, said method comprising at least the steps of:
controlling numerical control deposition means to deposit material particles on a continuously advancing support to form the pattern, and
heating the material particles on the support to bond same and form the base layer, the support being secured to the base layer.

3. The process for continuously manufacturing a floor or wall covering according to claim 1, wherein the process comprises at least one step prior to the step of depositing the particles and of:
depositing a liquid plastisol layer on the continuously advancing support,
optionally, pre-gelling the plastisol layer.

4. The process for continuously manufacturing a floor or wall covering according to claim 2, wherein the support is a reinforcement frame.

5. The process for continuously manufacturing a floor or wall covering according to claim 2, wherein the support is a backing layer made of polymer materials.

6. The process for continuously manufacturing a floor or wall covering according to claim 1, wherein the process comprises at least one additional step of:
pressing the material particles onto the support.

7. The process for continuously manufacturing a floor or wall covering according to claim 1, wherein the deposition means are movable with respect to the continuously advancing support.

8. The process for continuously manufacturing a floor or wall covering according to claim 1, wherein said process comprises at least one additional step before the heating step of:
depositing a material particle layer on the support.

9. A floor or wall covering having at least one base layer, wherein the base layer is obtained by a manufacturing process according to claim 1.

10. The process for continuously manufacturing a floor or wall covering according to claim 2, wherein the process comprises at least one step prior to the step of depositing the particles and of:
depositing a liquid plastisol layer on the continuously advancing support,
optionally, pre-gelling the plastisol layer.

11. The process for continuously manufacturing a floor or wall covering according to claim 2, wherein the process comprises at least one additional step of:
pressing the material particles onto the support.

12. The process for continuously manufacturing a floor or wall covering according to claim 2, wherein the deposition means are movable with respect to the continuously advancing support.

13. The process for continuously manufacturing a floor or wall covering according to claim 2, wherein said process comprises at least one additional step before the heating step of:
depositing a material particle layer on the support.

14. A floor or wall covering having at least one base layer, wherein the base layer is obtained by a manufacturing process according to claim 2.
